(19) United States
(12) Patent Application Publication
(10) Pub. No.: US 2005/0211914 A1
(43) Pub. Date: Sep. 29, 2005

(54) Device for verifying security features

(75) Inventors: Klaus Franken, Igis (CH); Jakob Grob, Mastrils (CH); Andreas Dostmann, Tamins (CH)

Correspondence Address: PILLSBURY WINTHROP SHAW PITTMAN LLP, 1650 TYSONS BOULEVARD, MCLEAN, VA, 22102, US

(73) Assignee: LANDQART, Landquart (CH)

(21) Appl. No.: 10/510,041

(22) PCT Filed: Mar. 25, 2003
(86) PCT No.: PCT/CH03/00192

§ 371 Date: Oct. 1, 2004

(30) Foreign Application Priority Data
Apr. 4, 2002 (CH) 572/02

(51) Int. Cl. G01N 21/64

(52) U.S. Cl. 250/461.1

(57) ABSTRACT

The invention relates to a device (20) for making security elements visible, which are provided in an object (8) and have at least one photoluminescent segment that is characterized by having a linearly polarized absorption. The aim of the invention is to obtain a device of this type that has a particularly simple and compact design. To this end, at least one UV light source, which is provided in the form of a UV diode (18), and at least one polarization filter (4) are arranged so that the light of the light source (18) is linearly polarized (12) by the polarization filter (4) and, in a dark space (17), strikes the object (8) with respect to the photoluminescent segments provided therein, and photoluminescent light (16) in the visible range emitted by the segment can be observed through an observation opening (10).

### TECHNICAL FIELD

The present invention relates to a device and a method for revealing security elements that are present in an object and that have at least one photoluminescent segment which is characterized by linearly polarized absorption.

A security element of this type has been described, for example in WO 00/19016.

### PRIOR ART

It is generally known that, for security papers and security articles quite generally, for example for banknotes, checks, stocks and shares, bonds, identity papers, passports, drivers' licenses, entry cards, postage stamps and similar documents or, for example, for bank cards, credit cards and the like, use is made of security elements which have the purpose of preventing or making difficult the forgery of these objects by an unauthorized persons (R. van Renesse, “Optical Document Security” (1997), Artech House, Boston). Equally, such security elements are used for the purpose of identifying the authenticity or validity of objects or, quite generally, permitting or making easier the identification of objects.

For example, the use of security threads or strips, which, for example, can consist of plastic coated with metal, in security papers is widespread, in particular for the use in banknotes and similar securities. If these security threads or strips are, for example, embedded in the security paper and the latter is subsequently printed, however, these security elements cannot readily be detected if the object is observed in reflection. However, they appear as a dark shadow when the object is transilluminated and is therefore observed in transmission.

In particular in order to ensure the security against forgery of security articles, for example of security papers, in recent times many proposals have been made relating to providing security elements with specific characteristics, so that not only the presence of security elements for itself but, in particular, also the presence of specific characteristics is intended to guarantee the authenticity of the secured object (U.S. Pat. No. 4,897,300; U.S. Pat. No. 5,118,349; U.S. Pat. No. 5,314,739; U.S. Pat. No. 5,388,862; U.S. Pat. No. 5,465,301, DE-A 1,446,851; GB 1,095,286). For instance, DE-A 1,446,851 has disclosed a security thread which has a multicolored microprint; in this case, the printing ink can also be fluorescent. The areas printed in different colors are so small or so close together in this thread that they cannot be distinguished by the naked eye and therefore appear to the observer as a single-colored pattern. On the other hand, the microprint and its different colors can be detected with the aid of a magnifying glass or a microscope.

Furthermore, reference is made to WO 00/19016, in which a security paper or quite generally security articles are described which contain at least one security element that has at least one photoluminescent segment which is distinguished by linearly polarized photoluminescence and/or linearly polarized absorption. In this document, it is pointed out that linearly polarized excitation light, which, for example, can be generated by an external light source in conjunction with a linear polarizer, is absorbed to different extents by the segment, depending on the orientation of the polarization axis of the segment and the polarization direction of the excitation light, which can lead to a high light/dark contrast when observed by the naked eye.

Furthermore, reference is made to U.S. Pat. No. 5,892,239, which describes an instrument for the identification of security features on a security document, in which unpolarized light is used for illumination and polarization is used during the detection. A similar device is described by U.S. Pat. No. 4,990,790.

In connection with such security features having photoluminescent segments with polarizing properties, there is a need for devices for the detection or verification of such security features. Such devices are to have a high resolution and good contrast and, at the same time, should be capable of implementation in a technically simple and in particular a very compact manner, that is to say should be resistant, easy to carry and capable of inexpensive production, in order to permit wide distribution.

### SUMMARY OF THE INVENTION

Accordingly, the invention is based on the object of providing a method and, respectively, a device for revealing security elements present in an object, the security elements to be observed having at least one photoluminescent segment which is characterized by linearly polarized absorption. The segment can additionally have polarized emission in the visible range.

The object, for example a banknote, can also contain further additional security features, however, which if appropriate can be verified with the same device.

At the same time, the device is to be very compact and to permit easy and reliable detection of the security elements without having to fall back on a complicated and possibly temperamental design.

This object is achieved in that at least one UV light source, in particular preferably in the form of a UV diode, and at least one polarization filter are arranged in such a way that the light from the light source is linearly polarized by the polarization filter, strikes the object and, respectively, the photoluminescent segments present therein in a dark chamber, and photoluminescent light from the segment in the visible range can be observed through an observation opening.

In other words, the nub of the invention is to provide in a complex design, in particular with the aid of one or more UV diodes, which can be extremely small and have a low power requirement, an instrument for verifying polarizing (in particular selectively absorbing only light of a specific polarization direction) and fluorescent security features, which can be produced inexpensively, is inexpensive in operation (simple batteries, low current consumption) and which is barely susceptible to faults. This is because it has transpired that, surprisingly, UV diodes have a light intensity which is entirely sufficient to build such a complex analysis instrument. Reliable observation even in daylight is ensured in this case by the arrangement of a dark chamber, in which the object having the security feature is illuminated by a UV light beam, and which dark chamber has a specific observation opening.

Instead of the UV diodes, use can also be made of another UV light source, an appropriate laser light source with emission in the correct UV range, but also conceivable are broadband light sources, in front of which there is connected an appropriate filter which allows only UV radiation to pass through. If appropriate, a filter of this type can also be a polarization filter at the same time, which in a corresponding way permits only UV radiation of a specific linear polarization direction to pass.

For this purpose, the observation opening is preferably configured in such a way that the region of the eye can be placed directly on the observation opening (if appropriate provided with a corresponding eye support, for example in the form of a rubber ring), in such a way that as little light as possible can get into the dark chamber.

According to a first preferred embodiment of the invention, the UV diode is a diode which emits light in the UV range from 300 to 400 nanometers, in particular in the range from 350 to 385 nanometers, the UV diode providing an optical output in the range from 0.5 to 20 mW, in particular preferably from 1 to 5 mW, given a current of 15 to 20 mA and room temperature.

The UV diode can, however, also emit light in a broader range, specifically in the UV range from 180 to 500 nanometers. Depending on the security feature used, a broader emission characteristic can be advantageous. Powers of the UV diodes outside the range specified above can also be used but higher powers are typically correspondingly associated with a higher current consumption, which has a detrimental effect on the lifetime of a battery used, and lower powers typically lead to a comparatively low light intensity and, accordingly, reduced detectability of the desired effect. However, the latter can possibly be compensated for either by means of a higher concentration (focusing) of the light beam or, for example, by means of electronic amplification of the signal reflected from the object.

Diodes of this type for the UV range are currently available in an extremely small design, for example with diameters in the range from 3 to 7 mm and a height of 3 to 10 millimeters, which makes them suitable for the use described here. In particular, it is in this way possible to construct the device such that it can be handled as a hand-held instrument and, for example, in the form of a small pen, it being possible, for example, for the object to be illuminated with one end with the aid of a UV light beam oriented substantially parallel to the axis and to be observed through an observation opening. A hand-held instrument of this type can be produced at low cost and, in particular, can be carried easily, for example in a vest pocket, which permits universal and mobile use as an analytical instrument.

In order to increase the quality of the observation further, according to a further preferred embodiment of the present invention, the observation can take place through a filter which substantially does not permit light in the wavelength range of the UV diode to pass, while light in the wavelength range of the visible photoluminescent light from the segment can pass substantially unimpeded. A filter of this type can simply be mounted in front of the observation opening and increases the quality of the observation as a result of the elimination of interfering signals. It is also possible, instead of a band-selective filter, to provide a rigid or possibly likewise mobile polarization filter in front of the observation path as well, so that only linearly polarized light emitted by the security feature in a specific polarization direction is observed. In this way, interfering signals are suppressed still more efficiently and observation is simplified and improved.

If the polarization filter is a polarization filter which, both in the UV range and in the visible range, lets through light only of a specific polarization direction, then a single such polarization filter can be placed both in the light beam of the light shone in or in the light path between object and observer. Thus, on one side the light shone in is linearly polarized and light emitted by the appropriately configured object and likewise linearly polarized is additionally filtered before the observation. In this way, the signal-to-noise ratio can be improved and, additionally, it may also be possible to verify security features which, although they exhibit no linearly polarized absorption, exhibit linearly polarized emission.

According to a further preferred embodiment, the polarization filter for observation can be rotated about an axis perpendicular to the plane of the polarization filter. While the light/dark effect occurring as a result of the polarization effects of the security features in the case of a rigid polarization filter becomes visible only if the hand-held instrument is rotated about an axis substantially perpendicular to the plane of the polarization filter, when there is a rotatable polarization filter present in the housing this effect can be brought about very simply and reliably. In this case, this rotation of the polarization filter can be provided via appropriate means, for example in the form of a pen to be moved, directly by hand or else with the aid of a transmission mechanism, in particular the rotation of the filter through at least 180 degrees preferably being possible. The transmission mechanism is preferably a possible way of setting the polarization filter rotating via a simple knob movement, for example with the thumb on one end of the pen. This can, for example, be carried out counter to a spring force, so that the polarization filter is rotated through at least 180 degrees by pressing the knob down and, when the knob is released, said polarization filter automatically rotates back into its original position again on account of the spring force. Mechanisms of this type can be implemented, for example, via a spiral spring and suitably deflected grooves. Alternatively, it is also possible to rotate the polarization filter with the aid of a small motor, it being possible for the polarization filter to be rotated with a rotation frequency in the range from 0.2 to 5 Hz, in particular preferably with a rotation frequency from 0.5 to 2 Hz. There can be an ability to rotate continuously.

Another preferred embodiment of the present invention is characterized in that the device is configured in the form of a pen which has a cylindrical housing to accommodate at least one battery and a diode and a lower cylindrical housing part, possibly with a larger diameter, the lower housing forming a cavity as a dark chamber with an observation opening, with which the object to be observed can be covered, the instrument in particular preferably having a length of less than 10 centimeters and, at its thickest point, a diameter of less than 2.5 cm. The observation opening is preferably an opening in the lower housing part in the form of a segment cutout extending from the lower edge of the lower housing part with an opening angle in the range from 90 to 150 degrees with a height of less than 1.5 cm.

The desired flip-flop effect can, as mentioned above, be produced by the hand-held instrument being rotated by the user about the observation axis or else by means being provided in order to rotate the polarization filter or filters in such a way that the polarization direction of the light aimed at the object is rotated. Alternatively, however, according to another preferred embodiment of the present invention, it is additionally possible to provide 2 or else more groups of at least one UV diode in each case, preferably of 2 UV diodes in each case, and to activate these groups in accordance with a specific pattern, each group throwing light with a different polarization direction onto the object. This can be implemented, for example, by 2 groups irradiating the object in a predefined, alternating manner, the first group throwing a cone of light with a first polarization direction onto the object, and the second group a cone of light with a second polarization direction, and the first polarization direction being aligned substantially perpendicular to the second polarization direction. By means of this alternate switching of the two groups on/off, a flip-flop effect is produced, which is similar to that which is produced when the polarization filter is rotated (for example continuously). However, the advantage of this solution is that there are no mechanical parts; instead the effect is produced exclusively by means of appropriate electrical or electronic activation of different groups.

It is also possible to provide 3 groups, for example, one group then throwing a polarization direction of zero degrees onto the object, a second group throwing a polarization direction of 45 degrees onto the object and a third group a polarization direction of 90 degrees. Other divisions are of course likewise possible, for example four groups in each case and polarization directions of zero, 30, 60, 90 degrees (30-degree section) or even in sections of 5, 10 or 15 degrees. Thus, to a certain extent, the rotation of the polarization filter can be simulated without having to have moving mechanical parts. The individual groups have to be activated appropriately sequentially. Of course, in the case of a higher number of groups, more UV diodes have to be arranged whereas, in the case of an arrangement of only 2 groups, for example security features having a relative arrangement of 45 degrees exhibit no flip-flop effect or only a very weak flip-flop effect, security features of this type can likewise be visualized well in the case of 3 groups, for example.

If, for example, 2 groups are provided, then the UV diodes are advantageously switched alternately on and off in groups, the change between the two groups being carried out at a frequency of 0.2 to 5 Hz, in particular preferably at a frequency of 0.5 to 2 Hz. If there are more than 2 groups, then these will be cycled one after another at a correspondingly higher speed, the intention being for the group at zero degrees and that at 90 degrees to be activated at the frequency specified above.

Alternatively, it is possible not to control the UV diodes in a simple on/off method but to activate these with a corresponding curve. For instance, the UV diodes of the 2 groups can be activated with a substantially sinusoidal intensity profile, the phase shift between the 2 groups being substantially 90 degrees. Activating the two groups in accordance with this pattern to a certain extent simulates the rotation of a polarization filter in front of all the diodes or, respectively, rotation of the polarization direction. Of course, appropriate activation in the case of more than 2 groups is possible and may be expedient.

An advantageous development of the abovementioned embodiment consists in there being two groups of respectively two UV diodes, in each case UV diodes belonging to one group being arranged opposite each other in relation to the observation axis and illuminating the object obliquely from above, for example, and the two groups being arranged to be displaced by 90 degrees around the observation axis. In this way, a compact arrangement of the UV diodes at the side of the observation path is possible and, in addition, in this way appropriately all orthogonally aligned polarization filters can simply be aligned in front of the respective group. In addition, the result is comparatively homogeneous illumination of the object and the illumination of the object is in principle similar in the case of activation of the first or the second (nth) group. Thus, effects which appear similar to the actually desired flip-flop effect but which can arise merely as a result of the alternate switching of the two groups and not because of the polarization effects can be avoided in an optimum way.

In principle, the procedure is, for example, such that a polarization filter is arranged in front of each UV diode, the orientation of the polarization direction of the polarization filters of the first group being aligned substantially perpendicular to the orientation of the polarization direction of the polarization filters of the second group. However, it is also possible to provide one polarization filter for each group or else, according to a further preferred embodiment, it is possible to provide a single polarization filter for all the groups, it then being necessary for this polarization filter to have appropriate characteristics such that, depending on the group, different polarization directions are incident on the object. This can be implemented, for example, by a cylindrical polarization filter being arranged between object and UV diodes, the axis of the cylindrical polarization filter substantially coinciding with the observation axis. A polarization filter of this type can perform this task if it permits only UV light which has a polarization direction parallel to the major axis of the cylinder to pass. A cylindrical polarization filter of this type which, for example, can consist of a rolled polarization film, can be used in combination with 2 groups of UV diodes but also in combination with any desired higher number of UV diodes if the latter are distributed appropriately over the circumference.

A further preferred embodiment of the present invention is characterized in that a holding arm and an observation tube are provided, the observation tube being aligned substantially at right angles to the holding arm.

Instead of or in addition to a filter, as has already been described above, according to a further preferred embodiment, the observation can be carried out through a lens, in particular preferably through a magnifying glass, that is to say a lens or a magnifying glass can be placed in front of or in the observation opening.

A further-reaching improvement in the visualization of the effects with appropriate electronic filtering possibilities, if appropriate, can be implemented by the observation being carried out by means of electronic aids, in particular in the form of a recording device such as a camera, in particular a digital camera, if appropriate in combination with a corresponding electronic visualization means such as a display.

Furthermore, it is possible to arrange in the observation axis a polarization filter which, in particular, preferably substantially does not permit light in the wavelength range of the UV diode to pass, while light in the wavelength range of the photoluminescent light from the segment can pass substantially only in a manner filtered with respect to its polarization direction. This arrangement is particularly advantageous when there are security elements which, in addition, exhibit linearly polarized emission. In addition, in this way it is also possible to verify photoluminescent security features which exhibit no linearly polarized absorption but only linearly polarized emission. A filter of this type can be rotated mechanically, if appropriate.

As already mentioned at the beginning, the device or the hand-held instrument can additionally have means for verifying other security features in the object. Such security features can be of an extremely wide range of types, for example magnetic, electric, optical, electronic or electro-optical features, for example selected from the group comprising bar codes, magnetic strips, conductivity, electroluminescence, photoluminescence, up-conversion (anti-Stokes), infrared signatures, electronically readable texts, also including infrared text (OCR text), X-ray fluorescence features, etc.

Preferred embodiments of the device according to the invention emerge from the independent claims.

The present invention also relates to a method of revealing security elements that are present in an object and that have at least one photoluminescent segment which is characterized by linearly polarized absorption. In this case, the method is characterized in that light from at least one light source in the form of a UV diode is linearly polarized by at least one polarization filter, is incident on the object or, respectively, on the photoluminescent segments present therein in a dark chamber, and photoluminescent light in the visible range from the segment is observed through an observation opening. In particular, the method is carried out by using a device as described above.

Further preferred embodiments of the method according to the invention emerge from the independent claims.

### BRIEF DESCRIPTION OF THE FIGURES

The invention is to be explained in more detail below using exemplary embodiments and in conjunction with the drawings, in which:

FIG. 1a) shows a perspective view of a hand-held instrument obliquely from below; b) shows a view from below with an indication of the ability of the polarization filter to rotate; c) shows a front view of the hand-held instrument with a view of the observation opening; d) shows a side view of the hand-held instrument with an illustration of the internal parts and an illustration of the observation; and

FIG. 2a) shows a view of a further hand-held instrument from below; b) shows a view of the hand-held instrument from above; c) shows a view from the front; d) shows a perspective view from below; e) shows a perspective view from above; f) shows a section along the line A-A in FIG. 2b); g) shows a schematic view from above of the structure of UV diodes and rolled polarization filter.

### PREFERRED EMBODIMENTS OF THE INVENTION

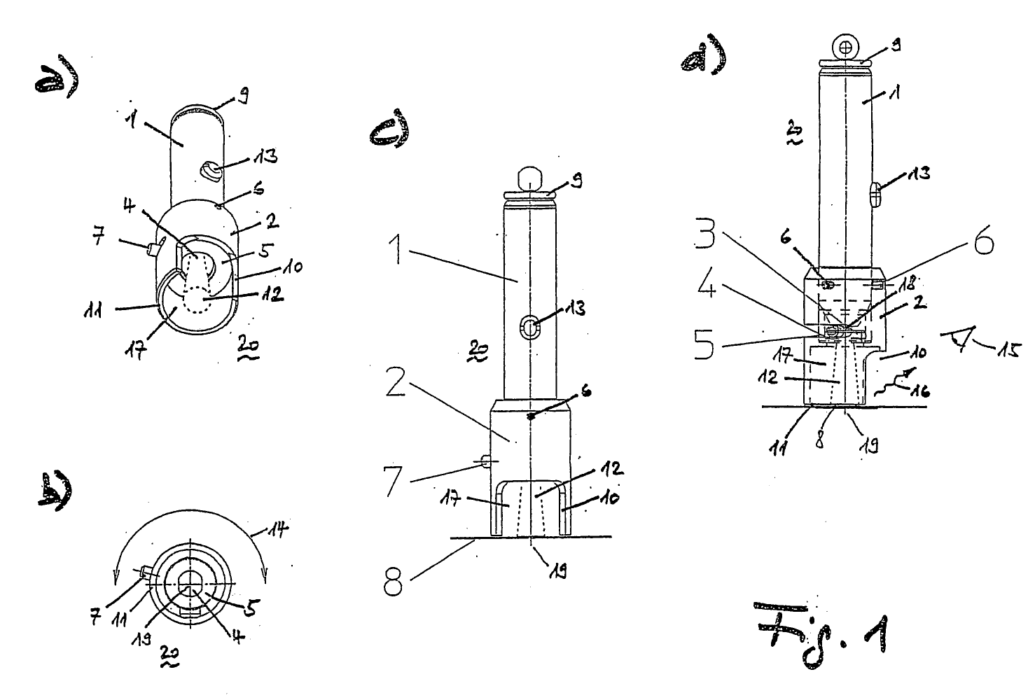

FIG. 1a) shows a perspective view of the hand-held instrument 20 obliquely from below. The hand-held instrument comprises a cylindrical housing 1, in which one or more batteries (for example, here, 3 button cells from VINNIC of the alkaline cell L1154 type; IEC design: LR44; diameter: 11.6 mm; height: 5.4 mm; voltage: 1.5 V; capacity: 164 mAh; standard current: 0.22 mA; weight: 1.88 g) can be accommodated, and which can be closed at the upper end by a screw-on cover 9. Also present on the cylindrical housing part is a switch 13, with which the UV light can be switched on and off. The cylindrical housing 1 has a diameter of 1.3 cm. At the lower end, there is arranged a lower housing part 2, which has a larger diameter of 2 cm. The lower housing part is fixed to the cylindrical housing part 1 by grub screws 6. Arranged in the interior of the lower housing part 2 and, respectively, at the end of the cylindrical housing part 1 is the UV light source, and also the polarization filter 4, which is oriented at right angles to the axis 19 of the hand-held instrument 20. The polarization filter 4 is held in a mount 5 and has a substantially round form. Suitable linear polarization filters are commercially available UV polarization filters, in practical terms, use was made of a filter from Polaroid under the trade name “HNP′B linear ultraviolet*”, with a spectral range of 275-750 nm (delivered size of 100×100×0.15 mm). In this case, the mount 5 is mounted such that it can be rotated about the axis 19 of the hand-held instrument and, in order to rotate the polarization filter 4, a pin 7 is fixed to the mount 5, which pin 7 projects outward through a corresponding slot-like opening in the lower housing part 5 and can be rotated by hand in order to view the light/dark effect of the polarizing security features as the polarization filter is rotated. In this specific case, the filter can be rotated through 180 degrees, but it is also possible to provide for the pin 7 a slot which permits an ability to be rotated by up to 270 or more degrees. In addition, it is possible to provide a spiral spring, so that the filter, after being rotated in one direction, returns automatically into the original position again.

It is also possible to set the polarization filter 4 rotating with a motor or else to provide a mechanism in which the polarization filter 4 can be rotated via a knob which is arranged in the region of the screw-on cover 9, for example, and can be operated with the thumb.

The lower housing part 2 at the lower end of the hand-held instrument 20 is formed as a tube, so that a dark chamber 17 is formed at the bottom, with which the object 8 to be observed can be covered. This prevents daylight interfering with the observation. The cone of light 12 which originates from the UV diode 18 and is linearly polarized by the polarization filter 4 passes along the axis 19 of the hand-held instrument into this dark chamber 17 and strikes the object 8 for the purpose of observation. The lower housing end 2 has an observation opening 10, which is configured in the form of a lateral cutout. This observation opening 10 can either be completely open or else can additionally be covered with a UV filter and/or with a lens, for example a magnifying glass, in order to improve the observation.

FIG. 1b) shows a view into the dark chamber 17 from below. In this case, in particular the range 14 of the rotation of the polarization filter 4, as can be swept over by hand via the pin 7, is indicated by a double arrow. In addition, it is possible to see that the polarization filter 4 does not necessarily have to be mounted in a circular mount 5.

FIG. 1c) shows a front view of a hand-held instrument 20. In this case, it is possible to see how the object 8 is covered by the lower housing part 2 for observation, so that the part of the object 8 which is to be examined is covered by the dark chamber 17 and in this way the daylight is effectively shielded. The observation is carried out through the observation opening 10. The entire device 20 has a height of 9 cm and can therefore easily be carried along in a vest pocket or the like.

For the purpose of analysis of an object 8 having security features, the object is placed on a flat surface and the hand-held instrument is guided over the object in such a way that the object is covered by the lower housing part 2. In the process, care should be taken that no interfering light can get into the interior 17 laterally between the object and the underside of the housing and in this way diminish the quality of the observation.

Finally, FIG. 1d) shows a side view of the hand-held instrument. Here, it is indicated how the observer 15 observes the light 16 emitted by the security features in the visible range through the observation opening 10. In addition, the arrangement of polarization filter 4 and diode 18 in the interior of the hand-held instrument 20 is indicated dashed. The UV diode 18 is diodes such as can be obtained, for example, from Roithner Lasertechnik, A-1040 Vienna under the designations RLT 370-110 (about 1 mW power on the major axis of the diode with a beam divergence of 110 degrees) and RLT 370-10 (about 0.75 mW power on the major axis of the diode with a beam divergence of 10 degrees, this model was used in the present exemplary embodiment on account of the focusing of the beam). These diodes emit light in the wavelength range from 350 to 400 nanometers, the maximum of the intensity being located at about 370 nanometers (spectral width at half height about 12 nanometers). The diodes are free of visible light. The powers specified result at 25 degrees Celsius and with a DC voltage of 3.9 V at 10 mA. These are in both cases GaN diodes, in which a lens is connected in front. Likewise possible are UV diodes based on GaN such as are offered by Toyoda Gosei Co. Ltd under the trademark “Purple”, for example with the type designations E1L5M-3P0AP-02 and E1L5M-4P0A2-01 and E1S09-0P0AP-02 (spectral range from 370 to 420 nanometers with a maximum at 385 nanometers, with a power in the range from 1 to 20 mW at room temperature).

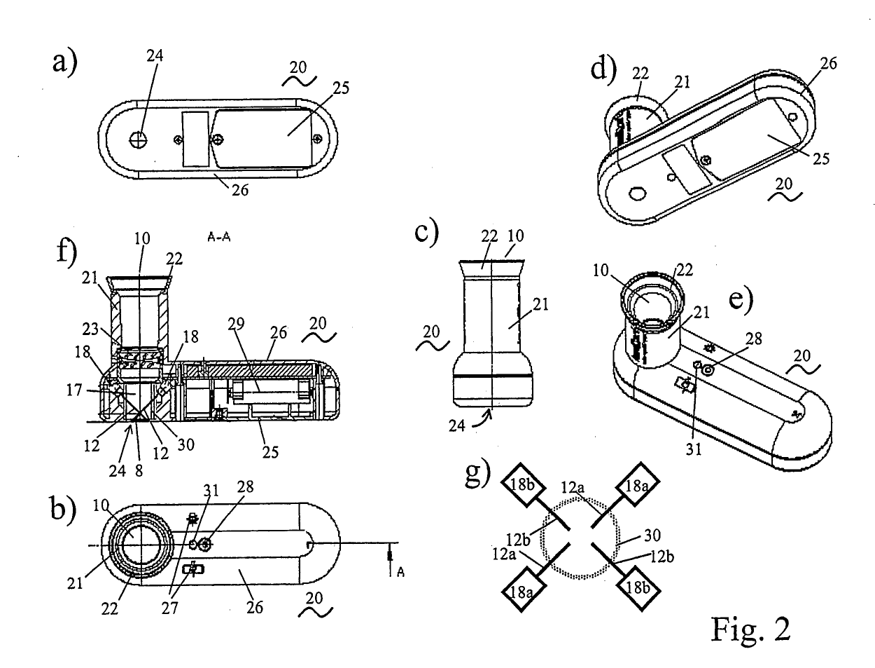

FIG. 2 shows a further exemplary embodiment to illustrate the present invention. In this case, FIGS. 2a) to 2c) show views from three spatial directions, and FIGS. 2d) and 2e) show perspective views obliquely from below and obliquely from above. In this case, identical designations in each case designate identical constituent parts.

The hand-held instrument of this exemplary embodiment is to a certain extent L-shaped, the instrument firstly being held by one of them, the holding arm 26, and secondly being placed on an object, such as a banknote or another object with appropriate security features. The other limb of the hand-held instrument is aligned orthogonally with respect to the holding arm 26 and comprises an observation tube 21. The observation tube 21 has an eye support 22, which is configured in a similar way to that encountered in telescopes or cameras. This is, for example, a peripheral rubber lip, on which the region around the eye can be placed. As a result, the dark chamber 17 that is present is not disrupted by light incident on the observer side.

Arranged in the housing of the holding arm 26 are batteries 29, which are accessible via a cover 25. This cover 25 is arranged on the underside of the hand-held instrument 20, where there is also a lower opening 24 on the observation axis, through which opening 24 the object 8 to be verified is viewed through the observation opening 10 during viewing.

On the upper side of the holding arm 26 there are the operating elements and the control elements. The operating elements are, firstly, a switch 28 for switching the UV diode 18 on. Additionally located there is a further switch 31, via which alternating activation of different groups of UV diodes can be triggered.

LEDs are additionally arranged on the upper side of the holding arm 26 as control elements, firstly for the state of the batteries 29 and secondly a control lamp which indicates whether the UV diodes are switched on.

FIG. 2f) shows a vertical section through the hand-held instrument according to the line A in FIG. 2b). On one side, it is possible to see here that lenses 23 are arranged in the observation path. These lenses 23 enlarge the object 8 observed through the observation opening 10 and through the lower opening 24. This is advantageous in particular, for example in the case of mottled fibers which, under certain circumstances, can be quite small.

In addition, the arrangement of the UV diodes 18 can be seen in FIG. 2f). The UV diodes 18 are arranged at the side of the observation path and irradiate the object 8 obliquely from above. In this case, the UV light 12 passes through a cylindrical polarization filter 30. The axis of this cylindrical polarization filter 30 is arranged parallel to the observation axis, and the polarization filter 30 allows only UV light which has a polarization direction parallel to the observation axis to pass.

If, then, as illustrated in FIG. 2g) in a schematic view from above, the UV diodes 18 are arranged around this cylindrical polarization filter 30, then the UV light falling on the object 8 will in this case have a first polarization direction for the oppositely arranged UV diodes 18a of a first group (cf. arrows in FIG. 2g)) and a second polarization direction, which is oriented at right angles to the first polarization direction, for the oppositely arranged UV diodes 18b of a second group. Thus, in a very simple way, by using a single polarization filter 30, it is possible for UV diodes 18 from different groups 18a and 18b to throw linearly polarized light 12a and 12b of orthogonal polarization direction onto the object 8.

The two groups 18a and 18b are now switched alternately on and off, so that in each case only UV diodes of a single group light up the object. Thus, alternating light beams which have a linear polarization direction of 0 and, respectively, 90 degrees in an alternating manner strike the object. A security feature for example whose polarized absorption direction is oriented parallel to the polarization direction of the light beam 12a will appear light, for example, when the group 18a is activated but, at the instant at which the second group 18b illuminates the object 8, such a security feature will appear dark. In this way, a flip-flop effect can be produced as if polarization filters were rotated.

### LIST OF DESIGNATIONS

1 Cylindrical housing
2 Lower housing part
3 Retaining ring
4 Polarization filter
5 Mount for polarization filter
6 Grub screw
7 Pin for rotation of polarization filter
8 Object having security feature
9 Screw-on cover
10 Observation opening in 2
11 Lower edge of 2
12 Cone of light (polarized UV light)
13 Switch
14 Rotation of polarization filter via 7
15 Observation
16 Light emitted by security feature
17 Dark chamber
18 UV diode
19 Axis of 20
20 Hand-held instrument
21 Observation tube
22 Eye support
23 Lenses
24 Lower opening
25 Cover of battery compartment
26 Holding arm
27 LED
28 On/off switch
29 Battery
30 Polarization filter
31 Flip/flop on/off switch

1. A device (20) for revealing security elements that are present in an object (8) and that have at least one photoluminescent segment which is characterized by linearly polarized absorption, characterized in that at least one UV light source, in particular preferably in the form of a UV diode (18), and at least one polarization filter (4, 30) are arranged in such a way that the light from the light source (18) is linearly polarized (12) by the polarization filter (4), strikes the object (8) and, respectively, the photoluminescent segment present therein in a dark chamber (17), and photoluminescent light (16) from the segment in the visible range can be observed through an observation opening (10).

2. The device (20) as claimed in claim 1, characterized in that the at least one UV diode (18) is a diode which emits light in the UV range from 180 to 500 nanometers, preferably from 300 to 400 nanometers, in particular in the range from 350 to 380 nanometers, and in that the UV light source or UV diode (18) preferably provides an optical output in the range from 0.5 to 20 mW, in particular preferably from 1 to 5 mW, given a current of 15 to 20 mA and room temperature.

3. The device (20) as claimed in claim 1, characterized in that the device (20) can be handled and is constructed in the form of a hand-held instrument such as, for example, in the form of a small pen, it being possible, for example, for the object (8) to be illuminated with one end with the aid of a UV light beam oriented substantially parallel to the axis (19) and to be observed through an observation opening (10).

4. The device (20) as claimed in claim 1, characterized in that the observation can take place through a filter which substantially does not permit light in the wavelength range of the UV light source or UV diode (18) to pass, while light in the wavelength range of the visible photoluminescent light (16) from the segment can pass substantially unimpeded.

5. The device (20) as claimed in claim 1, characterized in that the polarization filter (4) for observation can be rotated about an axis perpendicular to the plane of the polarization filter (4).

6. The device (20) as claimed in claim 5, characterized in that the rotation of the polarization filter (4) can be provided via appropriate means (7) directly by hand or else with the aid of a transmission mechanism, and in that, in particular, the rotation of the filter (4) through at least 180 degrees is preferably possible.

7. The device (20) as claimed in claim 5, characterized in that the polarization filter (4) can be rotated with the aid of a motor, and in that in this case the polarization filter (4) can be rotated with a rotation frequency in the range from 0.2 to 5 Hz, in particular preferably with a rotation frequency from 0.5 to 2 Hz.

8. The device (20) as claimed in claim 1, characterized in that the device is configured in the form of a pen which has a cylindrical housing to accommodate at least one battery and a diode (18) and a lower cylindrical housing part (2), the lower housing part (2) forming a dark chamber (17) with an observation opening (10), with which the object (8) to be observed can be covered, the instrument (20) in particular preferably having a length of less than 10 centimeters and, at its thickest point, a diameter of less than 2.5 cm.

9. The device (20) as claimed in claim 8, characterized in that the observation opening (10) in the lower housing part (2) is formed in the form of a segment cutout extending from the lower edge (11) of the lower housing part (2) with an opening angle in the range from 90 to 150 degrees with a height of less than 1.5 cm.

10. The device (20) as claimed in claim 1, characterized in that 2 groups of at least one UV light source or UV diode (18) in each case, preferably of 2 UV diodes (18) in each case, are arranged, and in that these 2 groups irradiate the object (8) in a predefined, alternating manner, the first group (18a) throwing a cone of light (12) with a first polarization direction onto the object (8), and the second group (18b) throwing a cone of light (12) with a second polarization direction onto the object (8), and the first polarization direction being aligned substantially perpendicular to the second polarization direction.

11. The device (20) as claimed in claim 10, characterized in that the UV light sources or UV diodes (18) are switched on and off alternately in groups, the change between the two groups being carried out at a frequency of 0.2 to 5 Hz, in particular preferably at a frequency of 0.5 to 2 Hz.

12. The device (20) as claimed in claim 10, characterized in that the UV light sources or UV diodes (18) of the 2 groups are activated with a substantially sinusoidal intensity profile, the phase shift between the 2 groups being substantially 90 degrees.

13. The device (20) as claimed in claim 10, characterized in that there are two groups of respectively two UV light sources or UV diodes (18), in each case UV light sources or UV diodes (18) belonging to one group (18a; 18b) being arranged opposite each other in relation to the observation axis and the two groups being arranged to be displaced by 90 degrees around the observation axis.

14. The device (20) as claimed in claim 13, characterized in that a polarization filter is arranged in front of each UV light source or UV diode (18), the orientation of the polarization direction of the polarization filters of the first group (18a) being aligned substantially perpendicular to the orientation of the polarization direction of the polarization filters of the second group (18b).

15. The device (20) as claimed in claim 13, characterized in that a cylindrical polarization filter (30) is arranged between object (8) and UV light sources or UV diodes (18), the axis of the cylindrical polarization filter (30) substantially coinciding with the observation axis and the polarization direction of the UV light (12) passing through the polarization filter (30) likewise being arranged parallel to the observation axis.

16. The device (20) as claimed in claim 15, characterized in that the cylindrical polarization filter (30) consists of a rolled polarization film.

17. The device (20) as claimed in claim 10, characterized in that a holding arm (26) and an observation tube (21) are provided, the observation tube being aligned substantially at right angles to the holding arm (26).

18. The device (20) as claimed in claim 1, characterized in that the observation is carried out through a lens, in particular preferably through a magnifying glass.

19. The device (20) as claimed in claim 1, characterized in that the observation is carried out by means of electronic aids, in particular in the form of a recording device such as a camera, in particular a digital camera, if appropriate in combination with a corresponding electronic visualization means such as a display.

20. The device (20) as claimed in claim 1, characterized in that the observation is carried out through a polarization filter which, in particular, preferably substantially does not permit light in the wavelength range of the UV diode (18) to pass, while light in the wavelength range of the photoluminescent light (16) from the segment can pass substantially only in a manner filtered with respect to its polarization direction.

21. The device (20) as claimed in claim 1 one of the preceding claims, characterized in that means for verifying further security features are provided at the same time.

22. The device (20) as claimed in claim 21, characterized in that the means permit the verification of magnetic, electric, optical, electronic, electro-optical features, preferably selected from the group comprising bar codes, magnetic strips, conductivity, electroluminescence, photoluminescence, up-conversion (anti-Stokes), infrared signatures, electronically readable texts, also including infrared text (OCR text), X-ray fluorescence features.

23. A method of revealing security elements that are present in an object (8) and that have at least one photoluminescent segment which is characterized by linearly polarized absorption, characterized in that light from at least ore light source in the form of a UV light source or preferably a UV diode (18) is linearly polarized (12) by at least one polarization filter (4), is incident on the object (8) or, respectively, on the photoluminescent segments present therein in a dark chamber (17), and photoluminescent light (16) in the visible range from the segment is observed through an observation opening (10), the method being carried out in particular with the aid of a device (20) as claimed in claim 1.
